(19) United States
(12) Patent Application Publication
(10) Pub. No.: US 2006/0112625 A1
(43) Pub. Date: Jun. 1, 2006

(54) Environmentally low-impact fertigation system

(76) Inventors: Clayton V. McNeff, Andover, MN (US); Larry C. McNeff, Anoka, MN (US); David Johnston, Anoka, MN (US)

Correspondence Address: PAULY, DEVRIES SMITH & DEFFNER, L.L.C., 900 IDS CENTER, 80 SOUTH EIGHTH STREET, MINNEAPOLIS, MN, 55402-8773, US

(21) Appl. No.: 10/966,350

(22) Filed: Oct. 15, 2004

(51) Int. Cl. A01G 29/00

(52) U.S. Cl. 47/48.5

(57) ABSTRACT

The present invention includes methods and devices for fertilization and irrigation. In an embodiment, the invention includes a method of operating a fertigation system including determining watering duration time and watering frequency for a plurality of watering zones, calculating an amount of a fertigation composition to be added to a water flow for each watering zone, and delivering the fertigation composition to the water flow in the amount calculated for each watering zone in an amount of time that is less than or equal to 75% of the total watering time for each watering zone. In an embodiment, the invention includes a fertigation system including a fertigation system controller that is adapted and configured to control a fertigation composition pump to deliver a fertigation composition to water delivery conduits in an amount of time that is less than or equal to 75% of the watering time for each watering zone.

### FIELD OF THE INVENTION

The present invention includes methods and devices for fertilization and irrigation. More specifically, the present invention includes methods and devices for efficient fertilization and irrigation.

### BACKGROUND OF THE INVENTION

Irrigation is used in both agricultural and non-agricultural applications to supply enough water to sustain a desired amount of plant growth. Fertilization is also used in both agricultural and non-agricultural applications to supply nutrients, such as nitrogen in amounts sufficient to support plant growth. Frequently, both irrigation and fertilization are necessary to support adequate plant growth for a particular application. By way of example, both irrigation and fertilization are conducted at most golf courses.

Systems that combine the functions of both fertilization and irrigation are known in the art and can be referred to as fertigation systems. By way of example, both U.S. Pat. No. 6,533,193 (White) and U.S. Pat. No. 6,314,979 (Lips) disclose fertigation systems. However, application of excess fertilizer is believed to be harmful to the environment. Excess fertilizer can be carried away from application areas along with rain water or irrigation water and transferred into rivers and lakes where it promotes harmful growth of certain aquatic plant species. Uptake of fertilizer by fish and wildlife may also lead to harm.

Accordingly, a need exists for efficient fertigation systems that minimize the environmental impact of fertilizer, herbicide, or pesticide applications.

### SUMMARY OF THE INVENTION

The present invention includes methods and devices for fertilization and irrigation. In an embodiment, the invention includes a method of operating a fertigation system including determining watering duration time and watering frequency for a plurality of watering zones, calculating an amount of a fertigation composition to be added to a water flow for each watering zone, and delivering the fertigation composition to the water flow in the amount calculated for each watering zone in an amount of time that is less than or equal to 75% of the total watering time for each watering zone.

In an embodiment, the invention includes a fertigation system including a water supply source, a back flow preventer in fluid communication with the water supply source, a fertigation composition pump in fluid communication with the water supply source, a fertigation composition supply tank containing a fertigation composition and in fluid communication with the fertigation composition pump, a plurality of water delivery conduits in fluid communication with the fertigation composition pump. The water delivery conduits are each adapted and configured to provide water to a watering zone, an irrigation system controller adapted and configured to control delivery of water from the water delivery conduits to the watering zones for a watering time that is specific to each watering zone, a fertigation system controller in electronic communication with the irrigation system controller and operably connected to the fertigation composition pump. The fertigation system controller is adapted and configured to control the fertigation composition pump to deliver the fertigation composition to the water delivery conduits in an amount of time that is less than or equal to 75% of the watering time for each watering zone.

The above summary of the present invention is not intended to describe each discussed embodiment of the present invention. This is the purpose of the figures and the detailed description that follows.

### DRAWINGS

The invention may be more completely understood in connection with the following drawings, in which:

FIG. 1 is schematic diagram of a fertigation system in accordance with an embodiment of the invention.

FIG. 2 is a flow chart showing a method of calculating chemical pumping time for each zone of a fertigation system.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

Application of excess fertilizer is believed to be harmful to the environment. Excess fertilizer can run-off and pollute waterways and groundwater sources. Embodiments of the present invention include efficient fertigation systems that can maximize the efficiency of fertilizer application.

In an embodiment of the invention, an injection time window for delivering a fertigation composition is calculated to be 75% or less of a watering duration time. In an embodiment, the injection time window is followed by post-delivery time of about 20% or more of the watering duration time; wherein water continues to flow and push the delivered fertigation composition into the soil and into the plant root zone within the watering zone. In an embodiment, the injection time window can also be preceded by an initial “warm-up” time of about 5% of the total watering duration time.

In an embodiment of the present invention, a surfactant can be provided to a fertigation coverage zone along with water and a fertilizer composition. Surfactants reduce the surface tension of water and can be inonic or nonionic in chemical nature. Surfactants can increase absorption of fertilizer components by plant matter in the fertigation coverage zone. Surfactants can also reduce the amount of water evaporation during irrigation when added to the composition delivered in a fertigation system. While not intending to be bound by theory, it is believed that a surfactant reduces the evaporation rate of water by effectively reducing the vapor pressure of water. In addition, the surfactant causes water to be more rapidly absorbed by soil such that the water is generally on the surface of the soil for a shorter period of time allowing less of a chance for the water to evaporate into the air.

In an embodiment of the present invention, a pesticide, such as an insecticide, or a herbicide, can be provided to a fertigation coverage zone along with water and a fertilizer composition. By way of example, application of a pesticide can provide benefits by reducing populations of insects in the fertigation coverage zone.

Fertigation System:

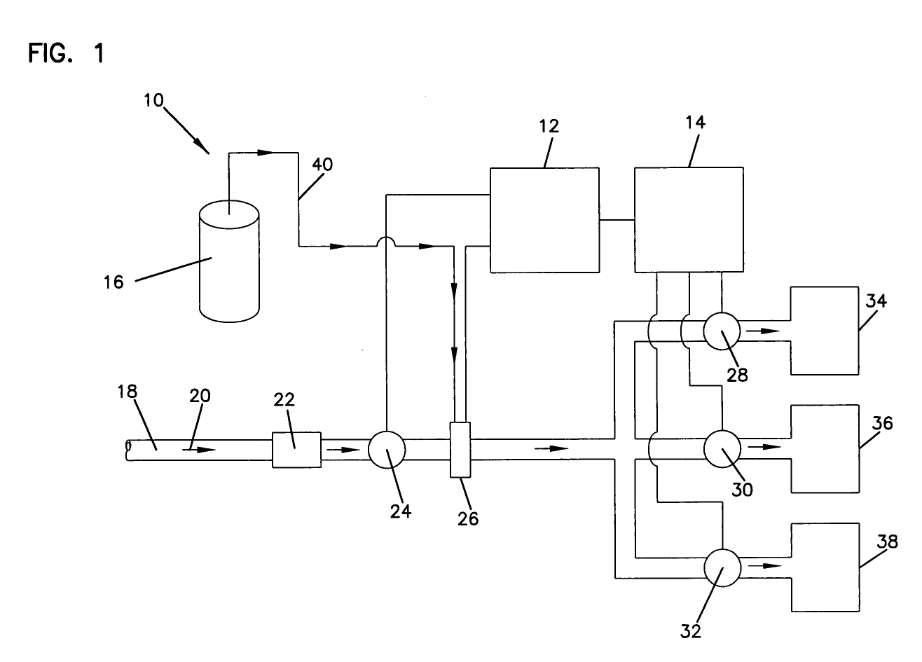

Referring now to FIG. 1, a water supply 18 provides water pressure that can allow water to flow into the fertigation system in the direction of arrow 20. The incoming water passes through backflow preventer 22 after it enters the system. By way of example, the backflow preventer can be a RPZ (reduced pressure zone) valve or assembly. Suitable RPZ valves include the Watts 009 QT reduced pressure zone assembly available from Watt Water Technologies, Inc., North Andover, Mass. However, one skilled in the art will appreciate that other devices can be used to prevent backflow including atmospheric vacuum breakers, anti-siphon valves, pressure vacuum breakers, double check backflow preventers, and the like. After the water passes through the backflow preventer 22, it passes on to the fertigation system control valve 24. Fertigation system control valve 24 is operably connected to the fertigation system controller 12. The fertigation system controller 12 causes the fertigation system control valve 24 to open and close. When fertigation system control valve 24 is in an open position, water flows to the composition injection pump 26. A fertigation composition is stored in the composition storage tank 16 and flows through composition supply line 40 to the composition injection pump 26.

Composition injection pump 26 is operably connected to fertigation system controller 12, such that fertigation system controller 12 controls the rate at which the composition injection pump 26 pumps the fertigation composition from the composition supply line 40 into the water line, forming a fertigation delivery solution. In an embodiment, the composition injection pump 26 is a variable speed computer controlled pump. In an embodiment, the stroke volume and the stroke rate of the pump can be controlled by fertigation system controller 12. The fertigation system controller can cause the composition injection pump 26 is operate at any level of capacity and for any length of time. The fertigation system controller 12 is adapted and configured to control the composition injection pump 26 in accordance with methods disclosed herein.

After leaving the composition injection pump 26, the fertigation delivery solution can proceed on to zone delivery valves 28, 30, and 32. Fertigation system controller 12 is in electronic communication with an irrigation system controller 14. The irrigation system controller 14 controls zone delivery valves 28, 30, and 32, which can open and close to allow fertigation delivery solution flow to zones 34, 36, and 38, respectively. The fertigation system controller 12 receives information from the irrigation system controller regarding which of the zone delivery valves 28, 30, and 32 are open and which are closed. Based on which of the zone delivery valves 28, 30, and 32, the fertigation system controller 12 can appropriately control the composition injection pump 26 to deliver the desired amount of fertigation composition into the flow of water. As the fertigation system controller 12 receives information regarding the zone delivery valves 28, 30, and 32 and controls the fertigation system control valve 24, the fertigation system can prevent fertigation composition from being added to the system when there is no water flow. In an embodiment (not shown) the fertigation system includes a flow meter to measure the rate of water flow through the system.

In some embodiments, the irrigation system controller 14 may only open one of the zone delivery valves (28, 30, or 32) at a time. In this manner, only one zone is receiving water or fertigation composition at a time and the zones are then fertigated in a sequential manner. In other embodiments, irrigation system controller 14 may open valves to multiple zones simultaneously such that the multiple zones are receiving water or fertigation composition at the same time. As information regarding which zones are open is passed to the fertigation system controller 12, it can appropriately deliver the desired amount of fertigation composition in either case.

As shown in FIG. 1, the irrigation system controller 12 and the fertigation system controller 14 are separate units in electronic communication. However, in an embodiment, the fertigation system controller and the irrigation system controller are the same unit.

Although three separate valves are shown in FIG. 1 to control the supply of fertigation delivery solution to three separate zones, one of skill in the art will appreciate that fewer valves can be used to similarly control the supply of fertigation delivery solution to three separate valves. By way of example, a single valve can be used to control flow to three separate conduits. In addition, while the fertigation system shown in FIG. 1 services three separate zones, one of skill in the art will appreciate that any number of zones could be accommodated. In an embodiment, the fertigation system includes one zone. In an embodiment, the fertigation system includes a plurality of zones.

In an embodiment, the present invention includes a fertigation composition including a pesticide. In an embodiment, the pesticide can include an insecticide. In this manner, populations of mosquitoes, gnats, ants, spiders, tics and other insects can be reduced in the irrigation watering zone.

In an embodiment, the present invention includes a surfactant along with the fertilizer. By way of example, the surfactant increases nitrogen uptake in the fertilized plants by promoting penetration of the nitrogen containing compounds into the plant roots.

In an embodiment, the fertigation system controller 14 includes a switch (not shown) that allows a user to suspend operations of the fertigation for a period of time. Instances may arise where a user wants to apply water without a fertigation composition. For example, if children are playing in or near the irrigation zone during the time of application. In an embodiment, the switch lights up to indicate that operation of the fertigation is suspended. The suspension can be for a defined period of time or indefinite. In an embodiment, the suspension is for a period of 12 hours after which the fertigation system automatically returns to normal operations.

In an embodiment, the fertigation system controller 14 is in electronic communication with a remote facility (not shown). In this manner, data regarding operation of the fertigation system (updates, reporting, trouble shooting information, etc.) can be transferred to the remote facility via electronic means such as a phone line, the Internet, telemetry, or the like. In an embodiment, the remote facility can reprogram the fertigation system controller 14 as is desired. In an embodiment, the fertigation system controller 14 can indicate when servicing or maintenance on the fertigation system is required.

Methods

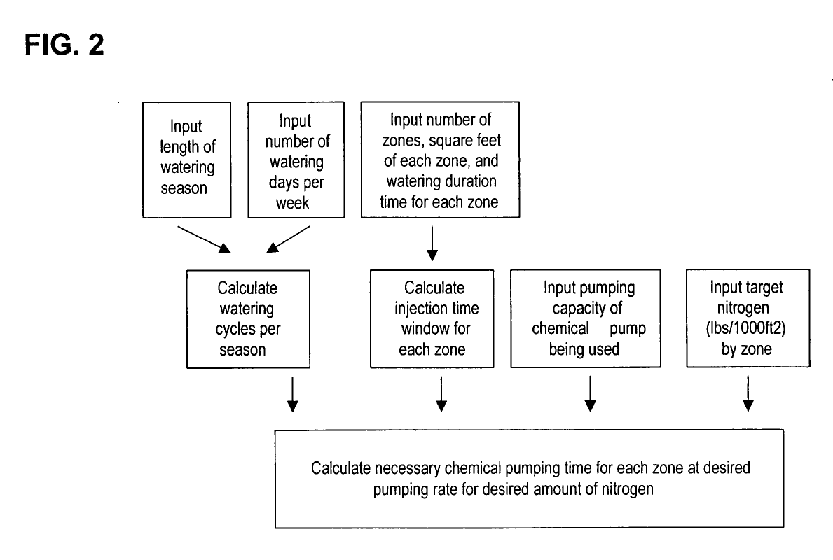

Referring now to FIG. 2, a flowchart illustrating a method of calculating chemical pumping time for each zone of a fertigation system is shown. The length of the water season can vary depending on geographic region. So the length of the watering season in days or weeks is input. Irrigation systems may be set up to water a certain number of days per week. It may be daily, every other day, or any number of times per week. Next, the number of watering days per week is input. Based on the total length of the watering season and the number of watering days per week, the number of watering cycles per season is calculated by multiplying the watering season length (in weeks) by the number of watering days per week.

The number of irrigation zones, the square feet of each zone, and the watering duration time for each zone is input. There can be any number of irrigation zones in an irrigation system depending on how many square feet are covered in total and how many square feet are desired in a particular zone. Watering duration time can depend on many factors including the type of vegetation in the zone, the use of the land in the zone, the volume of water to be delivered, etc. After watering duration time is known for a given watering zone, then an injection time window is calculated for the watering zone. In an embodiment of the invention, the injection time window is calculated to be 75% of the total watering duration time. By way of example, if the watering duration time for a particular watering zone is 100 minutes, then the injection time window would be 75 minutes. By limiting the injection time window to no more than 75% of the watering duration time, there is time left in the watering duration to run additional water through the system, without additional fertigation composition, in order to push more of the fertigation composition into the soil instead of some being left on the surface and in order to flush the irrigation system of any residual fertilizer, which could precipitate and cause malfunction of the irrigation system. It is believed that a greater amount of a fertigation composition can penetrate the surface of the ground if application of the fertigation composition is followed by application of an amount of water that does not contain a fertigation composition. In an embodiment, after the fertigation composition is applied, the system continues to supply water to the irrigation zone of a period of time equal to at least 20% of the watering duration time for the particular zone. By way of example, if the watering duration time is 100 minutes, then at least 20 minutes is reserved for the flow of water to the watering zone without the addition of the fertigation composition. In an embodiment, at least 15% of the watering duration time is reserved for supplying water without the fertigation composition.

In an embodiment of the invention, the composition injection pump is controlled such that addition of the fertigation composition is metered out over a length of time. It is believed that delivering the fertigation composition all at one time, or as one “slug”, can lead to less effective fertigation composition distribution. By way of example, in some irrigation systems it may take a period of time before all areas within a watering zone have received an equal amount of irrigation. Where the fertigation composition is delivered all at one time, this can lead to some areas of the water zone receiving too much fertigation composition and some areas receiving too little. In an embodiment, the composition injection pump delivers the fertigation composition over a period of time that is at least 50% of the total watering time for the particular watering zone. In an embodiment, the composition injection pump delivers the fertigation composition over a period of time that is at least 65% of the total watering time for the particular watering zone. In an embodiment, the composition injection pump delivers the fertigation composition over a period of time that is at least 75% of the total watering time for the particular watering zone.

The pumping capacity of the chemical pump in the fertigation system is input. One of skill in the art will appreciate that pumps are readily available in a wide variety of capacities. In an embodiment, the pump is a variable speed computer controlled pump. In such a case, the maximum pumping capacity of the chemical pump is input. The target amount of fertigation composition for a given amount of square feet per year is input for each watering zone. By way of example, where the fertigation composition comprises a nitrogen component, the target amount of nitrogen per 1000 ft² per year is provided. However, one of skill in the art will appreciate that the target amount could be of another component besides nitrogen. For example, the target component could be phosphorus or potassium. The target amount of a particular component of the fertigation composition on a per year basis may vary with the type of vegetation that is growing in the irrigation zone.

Based on the above inputs, the necessary chemical pumping time for each zone can be calculated. By way of example, the necessary chemical pumping time can be calculated assuming the pump will be run at a rate equivalent to 50% of its maximum capacity. However, one of skill in the art will appreciate that that pump can be run at a variety of levels and this will impact the necessary chemical pumping time accordingly. For example, based on the above inputs, the appropriate pumping speed of the pump can be calculated so that the fertigation composition is delivered over the entire injection time window.

It will be appreciated that the apparatus and methods of the invention described herein can be used in the context of many different types of irrigation systems and growing methods. By way of example, the invention can be applied to hydroponic growing methods in addition to traditional soil-based growing methods.

Fertigation Compositions

Fertigation compositions used in embodiments of the invention can include fertilizers of all types, pesticides, wetting agents or surfactants, etc. Fertilizers can include amounts of nitrogen, phosphorus, and potassium. Fertilizers may also include other components such as magnesium, calcium, sulfur, iron, manganese, zinc, boron, molybdenum, and organic components.

Pesticides can include organophosphates, carbamates, organochlorines, pyrethroids, microbial pesticides, and the like. Pesticides can specifically include algicides, antimicrobials, biopesticides, biocides, fungicides, herbicides, insecticides, miticides, microbial pesticides, molluscicides, nematicides, ovicides, repellents, rodenticides, mole repellants, and the like.

Surfactants reduce the surface tension of water. Surfactants can also be referred to as wetting agents. Surfactants can increase the spreading or penetrating ability of a liquid (such as water) over a surface. Surfactants used with embodiments of the invention include anionic, cationic, nonionic, and amphoteric surfactants. In an embodiment, the surfactant is a nonionic surfactant. In an embodiment the surfactant is a saponin containing composition. In an embodiment, the surfactant is an extract of Yucca. In an embodiment, the surfactant is an extract of Yucca Schidigera.

Saponins and Saponin Containing Compositions

In an embodiment, the fertigation composition can include a surfactant comprising saponins. Saponins are natural plant surfactants that occur in over 500 different plant species belonging to some 80 different families. Saponins occur naturally in many foods consumed by humans including soybeans, peas, spinach, beetroot and asparagus. They are generally recognized by their strong foaming action when placed in water, which has made them especially useful in the manufacture of foods, beverages, shampoos, wetting agents and pharmaceuticals.

Saponins are classified as surfactants because they have both lipophilic and hydrophilic “regions”. Thus, the surfactant activity of saponins is a result of both fat-soluble and water-soluble moieties in the same molecule. The lipophilic region may be a steroid, triterpene or alkaloid, and is termed a sapogenin. The hydrophilic “region” contains one or more water-soluble carbohydrate side chains. Yucca derived saponins generally have steroidal sapogenins.

The structural complexity of saponins is derived largely from the carbohydrate portion of the molecule due to the many different types of possible side chain carbohydrates, such as glucose, xylose, galactose, pentose or methylpentose, which may have different connectivity and/or anomeric configuration.

As different plant types contain varying concentrations of saponins, only extracts from some types of plants may be effective in accordance with the invention. By way of example, saponins useful in the present invention may also be extracted in sufficient concentrations from plants of the family: Amaryllidaccae, genus: Agave, which grows extensively in the southwestern United States and in Mexico. Saponins useful in the present invention may also be extracted in sufficient concentrations from plants of the family: Lillaecae, genus: Yucca, as well as from Quillaja saponaria bark. Saponins may be extracted from plant materials in accordance with techniques well-known by those of skill in the art.

The Yucca plant is a wide-ranging genus, which is part of the Century plant family, Aguavacea. Taxonomically there are 30 species within the Yucca genus, Schidigera being one. Yucca plants thrive mainly in semi-arid climates such as are found in India, Angola, Italy, Southwest U.S., and Mexico to name a few.

The EPA has ruled that Yucca extract is exempt from the requirement of a tolerance. In regards to toxicology, an acute oral gavage toxicity study performed on Sprague-Dawley derived rats was performed using a 70% yucca extract syrup. The LD50 for males was found to be greater than 5,000 mg/kg, and for females it was calculated to be greater than 500 mg/kg.

The typical saponin content that naturally occurs in yucca plants is from 0.1-2% saponins by weight. Yucca extracts can be derived by extracting yucca powder with an aqueous solution that may or may not contain some fraction of organic solvent such as methanol, ethanol, propanol, butanol, or the like. Commercially available Yucca extracts can have a total solids content usually in the range from 5-50%. The saponin content of a typical 50 brix (50% solids by weight) yucca extract is usually in the range of about 0.4-10% by weight.

Exemplary liquid solutions containing saponins are available commercially and sold under the trademarks SARGRO®, ACCUGRO®, ACCUGRO-BC® by SARTEC® Corporation of Anoka, Minn.

The present invention may be better understood with reference to the following examples. These examples are intended to be representative of specific embodiments of the invention, and are not intended as limiting the scope of the invention.

### EXAMPLE

### Example 1

### Calculating Chemical Pumping Time

An irrigation system has three zones (A, B, and C), wherein zones A and B are each 4000 square feet and zone C is 8000 square feet. Watering durations for zones A and B are 60 minutes each and the watering duration for zone C is 120 minutes. It is determined that the watering season for the geographic region in which the irrigation system exists is 140 days (or 20 weeks). The irrigation system is set up to operate 3 days per week over the watering season. It is calculated that there are 60 water cycles per season. The injection window is calculated to be 75% of the water duration of each zone. Accordingly, the injection window is calculated to be 45 minutes each for zones A and B and 90 minutes for zone C.

The maximum pumping capacity of the pump being used to inject fertilizers into the system is determined to be 6 gallons/day. This is converted to be 15.8 cc/minute at maximum capacity or 7.9 cc/minute at 50% capacity. The target nitrogen delivery in this example is 1 lbs/1000 ft² per season. Therefore, the target nitrogen delivery per season is calculated to be 4 pounds each for zones A and B, and 8 pounds for zone C. Based on 60 watering cycles as described above, it is calculated that 0.0665 pounds of nitrogen must be delivered per water cycle for zones A and B, and that 0.133 pounds of nitrogen must be delivered per water cycle for zone C. Based on a fertilizer solution containing 4.65×10⁻⁴ pounds of nitrogen per cc, it is calculated that approximately 286 cc of fertilizer solution must be delivered to each of zones A and B, and that 572 cc of fertilizer solution must be delivered to zone C. The necessary chemical pumping time at 50% of the max pumping rate of the chemical pump is approximately 36 minutes for each of zones A and B, and approximately 72 minutes for zone C.

While the present invention has been described with reference to several particular implementations, those skilled in the art will recognize that many changes may be made hereto without departing from the spirit and scope of the present invention.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “adapted and configured” describes a system, apparatus, or other structure that is constructed or configured to perform a particular task or adopt a particular configuration to. The phrase “adapted and configured” can be used interchangeably with other similar phrases such as arranged and configured, constructed and arranged, adapted, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

We claim:

1. A method of operating a fertigation system comprising:
determining watering duration time and watering frequency for a plurality of watering zones;
calculating an amount of a fertigation composition to be added to a water flow for each watering zone; and
delivering the fertigation composition to the water flow in the amount calculated for each watering zone in an amount of time that is less than or equal to 75% of the total watering time for each watering zone.

2. The method of claim 1, wherein the step of calculating an amount of fertigation composition to be added to a water flow for each watering zone comprises:
determining the total amount of fertigation composition to be added to a particular watering zone over a watering season based on the square footage of the watering zone and the type of plant matter growing in the watering zone; and
dividing the total amount of fertigation composition to be added to a particular watering zone by the total number of watering days in the watering season.

3. The method of claim 1, further comprising the step of delivering water flow to each of the watering zones, after the step of delivering the fertigation composition to the water flow, for an amount of time that is at least 20% of the total watering time for each water zone.

4. The method of claim 1, the fertigation composition comprising a nitrogen source and a surfactant.

5. The method of claim 4, the surfactant comprising saponins.

6. The method of claim 4, the surfactant comprising an extract of Yucca.

7. The method of claim 4, the surfactant comprising an extract of Yucca Schidigera.

8. The method of claim 4, the fertigation composition further comprising a pesticide.

9. The method of claim 4, the fertigation composition further comprising a herbicide.

10. A fertigation system comprising:
a water supply source;
a back flow preventer in fluid communication with the water supply source;
a fertigation composition pump in fluid communication the water supply source;
a fertigation composition supply tank containing a fertigation composition and in fluid communication with the fertigation composition pump;
a plurality of water delivery conduits in fluid communication with the fertigation composition pump, wherein the water delivery conduits are each adapted and configured to provide water to a watering zone;
an irrigation system controller adapted and configured to control delivery of water from the water delivery conduits to the watering zones for a watering time that is specific to each watering zone; and
a fertigation system controller in electronic communication with the irrigation system controller and operably connected to the fertigation composition pump, wherein the fertigation system controller is adapted and configured to control the fertigation composition pump to deliver the fertigation composition to the water delivery conduits in an amount of time that is less than or equal to 75% of the watering time for each watering zone.

11. The fertigation system of claim 10, the fertigation system controller adapted and configured to stop the fertigation composition pump from delivering the fertigation composition to each water delivery conduits prior to the end of the watering time for each watering zone.

12. The fertigation system of claim 10, wherein the irrigation system controller continues to deliver water from the water delivery conduits to the watering zones after the fertigation system controller stops the fertigation composition pump from delivering the fertigation composition to each water delivery conduit, for a period of time that is at least 20% of the watering time for each particular watering zone.

13. The fertigation system of claim 10, wherein the fertigation system is part of a hydroponic system.

14. The fertigation system of claim 10, the fertigation composition comprising a nitrogen source and a surfactant.

15. The fertigation system of claim 14, the surfactant comprising saponins.

16. The fertigation system of claim 14, the surfactant comprising an extract of Yucca.

17. The fertigation system of claim 14, the surfactant comprising an extract of Yucca Schidigera.

18. The fertigation system of claim 14, the fertigation composition further comprising a pesticide.

19. The fertigation system of claim 14, the fertigation composition further comprising a herbicide.

20. The fertigation system of claim 10, the fertigation composition pump comprising a variable speed chemical pump.

21. The fertigation system of claim 10, further comprising a switch configured to suspend operations of the fertigation system.
